(19) United States
(12) Patent Application Publication
(10) Pub. No.: US 2010/0058475 A1
(43) Pub. Date: Mar. 4, 2010

(54) FEEDBACK-GUIDED FUZZ TESTING FOR LEARNING INPUTS OF COMA

(75) Inventors: Suresh Thummalapenta, Raleigh, NC (US); Guofei Jiang, Princeton, NJ (US); Sriram Sankaranarayanan, Plainsboro, NJ (US); Franjo Ivancic, Princeton, NJ (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc., Princeton, NJ (US)

(21) Appl. No.: 12/397,041

(22) Filed: Mar. 3, 2009

Related U.S. Application Data
(60) Provisional application No. 61/091,865, filed on Aug. 26, 2008.

(51) Int. Cl. G06F 15/18; G06F 11/00

(52) U.S. Cl. 726/25; 714/38

(57) ABSTRACT

Embodiments of the present invention combine static analysis, source code instrumentation and feedback-guided fuzz testing to automatically detect resource exhaustion denial of service attacks in software and generate inputs of coma for vulnerable code segments. The static analysis of the code highlights portions that are potentially vulnerable, such as loops and recursions whose exit conditions are dependent on user input. The code segments are dynamically instrumented to provide a feedback value at the end of each execution. Evolutionary techniques are then employed to search among the possible inputs to find inputs that maximize the feedback score.

### RELATED APPLICATION INFORMATION

This application claims priority to provisional application Ser. No. 61/091,865 filed on Aug. 26, 2008 incorporated herein by reference.

### BACKGROUND

1. Technical Field

The present invention relates to computer analysis and more particularly to the detection of resource exhaustion denial of service attacks.

2. Description of the Related Art

For software running as a service, for example in enterprise systems, it is critical to maintain high reliability, security and availability. Resource exhaustion attacks can cause denial of service in such systems. Denial of service attacks can enable malicious users to control the system and deny access to legitimate users. Such attacks can be mounted by flooding, i.e., increasing the load on the system by sending many dummy requests. Recently, however, denial of service attacks have been mounted without flooding by exploiting defects and idiosyncrasies present in code. Such attacks are mounted by crafting “inputs of coma”. Inputs of coma are relatively small input strings that conform to the sanitization checks performed by the system over the input. However, they also lead to excessive utilization of bounded resources, such as CPU time, memory, stack space and sockets, and often cause the resource utilization to peak during their processing.

FIG. 1 shows an example of a function that includes potential CPU exhaustion vulnerability due to the possibility of a long running loop in line 14. The function “acceptOC” processes the user input in the form of a string “inpChar”. The sanity check in the beginning of the function processes strings satisfying the regular expression R:“‘{‘*’:‘ ’}*•Σ*”. Note that the condition check in line 1 limits the size of the string to 10000. Strings satisfying the regular expression and of length less than the limit reach the loop in line 14.

Nevertheless, not all such strings can cause a vulnerability. For instance, the string “:abch” passes the sanity checks in the function and causes the loop to run exactly once. On the other hand the string “{{:}}” causes the same loop to run for 27 iterations. A review of the behavior of the code demonstrates that for any fixed length l, the pattern

$${{(}^{′} {{\{}^{′} )}^{⌊ \frac{1}{2} ⌋} {}_{}^{′}{\text{:}}{}_{}^{′} {{(}^{′} \}}^{′} )}^{⌊ \frac{1}{2} ⌋}$$

maximizes the number of loop iterations, causing the loop to run for at least

$${⌊ \frac{l}{2} ⌋}^{3}$$

iterations. Further, strings that are close the pattern shown above while still satisfying the regular expression R cause the number of loop iterations to be close to the maximum.

Given such a program, the user may craft a string of length 10000 consisting of 4999 opening braces followed by character and 4999 closing braces. Such a string forms an “input of coma” causing the loop in line 14 to run for 125×10⁹ iterations. Assuming that the body of the loop cannot be optimized away, this leads to a CPU exhaustion attack, in practice. Even though this example is contrived, it reflects a pattern commonly observed in more complex CPU exhaustion vulnerabilities, for example in a PHP-Mailer.

Testing software to reveal the presence of such attacks plays a very important part of software development, especially for enterprise systems. Fuzz testing is a popular approach for discovering security vulnerabilities in software by formulating many random inputs. One form of fuzz testing called smart fuzzing crafts inputs uniformly at random that can pass through certain sanity checks enforced by the code. However, uniform random testing is inadequate for the purpose of ensuring robustness against input of coma attacks. The large space of possible legal inputs to a large software system makes such a method ineffective in practice.

Other approaches have employed a static analysis, which analyzes the software exhaustively and produces useful warnings. FIG. 2 depicts a common static analysis technique. In FIG. 2, source code 210 is analyzed via control dependency analysis 220 and/or taint analysis 230. These analyses output warnings of potential vulnerabilities in the source code, 240. The warnings produced by static analysis systems identify the specific portions of the code that may be controlled by user input to cause resource exhaustion.

In searching for inputs of coma, many static analysis tools focus on the analyzing long running loops and recursive function invocation in the code, wherein the exit conditions of the loops and recursion in question are tainted by user input. One such tool, called SAFER, has been used to analyze large software systems. In practice, the incompleteness of SAFER results in many false positives. Nevertheless, static tools such as SAFER are promising. Some of the warnings produced using SAFER have been shown to lead to new exploits through a manual code review based on static information. However, in many cases, it is labor intensive to have humans manually check all the warnings issued by SAFER to determine whether the warning represents a true vulnerability or a false positive.

### SUMMARY

Embodiments of the present invention combine static analysis, source code instrumentation and feedback-guided fuzz testing to automatically detect resource exhaustion denial of service attacks in software and generate inputs of coma for vulnerable code segments. The static analysis of the code highlights portions that are potentially vulnerable. Such regions include loops and recursions whose exit conditions are dependent on user input. The sanity checks performed over inputs to protect such regions are identified and analyzed to obtain program invariants that over-approximate their behavior.

Using the statically gathered information, embodiments the present invention dynamically instrument the code to provide a feedback value at the end of each execution. The instrumentation is used to monitor the resource usage as well as the behavior of the sanitization loop. The value of feedback provided is higher for inputs that pass the sanity checks and cause larger resource utilization. Evolutionary techniques are then employed to search among the possible inputs to find inputs that maximize the feedback score. In this manner, embodiments of the present invention detect vulnerabilities in systems (such as CPU time and stack exhaustion attacks) left undetected by systems employed by the prior art. As such, embodiments of the present invention may be used to fix security problems in program code and produce a more secure system.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a set of computer program commands which may be vulnerable to an “inputs of coma” attack.

FIG. 2 is a block/flow diagram depicting a static analysis technique employed by the prior art.

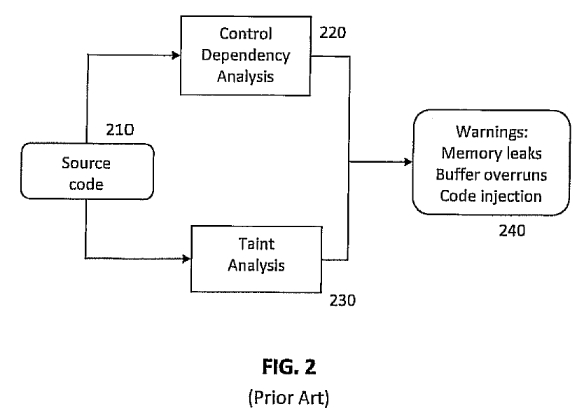

FIG. 3 is a block/flow diagram representing an overview of one embodiment of the present invention.

FIG. 4 is a block/flow diagram detailing the analysis performed by an illustrative embodiment of the present invention.

FIG. 5 is an abstraction for the code presented in FIG. 1 generated by the local static analysis performed in accordance with the present principles.

FIG. 6 is a sample set of PHP code for PHPMailer v.1.72

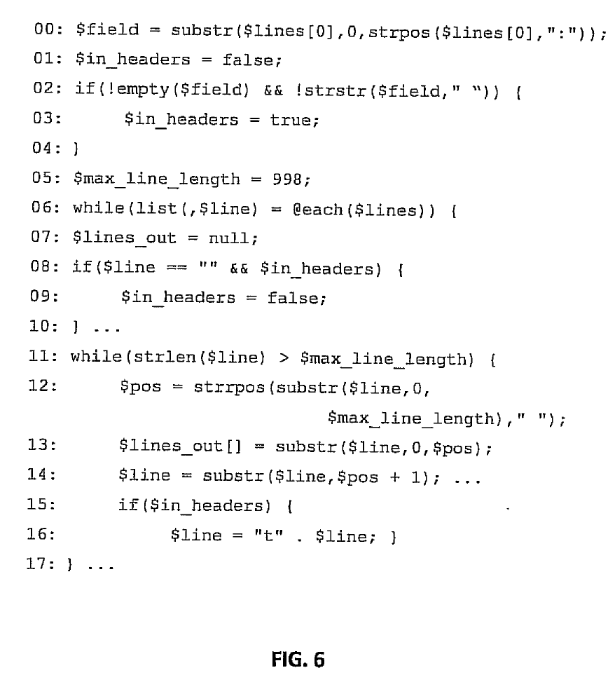

FIG. 7 is the automaton generated from the PHPMailer code provided in FIG. 6 by the local static analysis performed in accordance with the present principles.

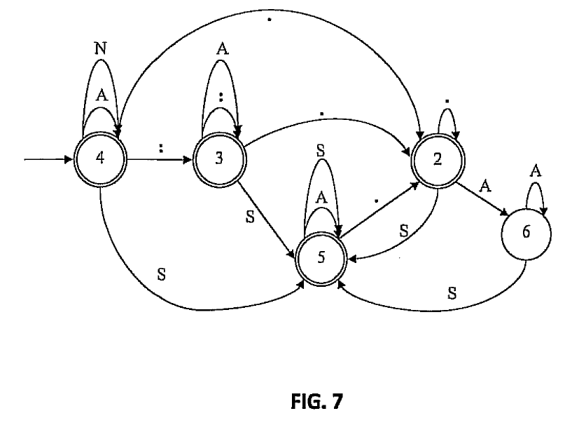

FIG. 8 is an exemplary denial of service detection system in which embodiments of the present invention may be implemented.

### DETAILED DESCRIPTION OF PREFERRED EMBODIMENTS

Embodiments of the present invention employ useful program facts gleaned by the static analysis of software to guide the brute-force approach of fuzz-testing to alleviate the effort of testing systems for vulnerabilities. Specifically, embodiments may use the warnings from a static analysis tool, such as SAFER described above, to focus the search on specific regions in the code. Focusing on the region of code highlighted by the warning, embodiments disclosed herein identify portions of code that process the user input leading up to the region of interest. These portions include sanity checks that perform checks on the inputs to reject certain input patterns. A static string analysis is then performed on the sanity checking functions to compute invariants in the form of automata and constraints that describe strings that pass the sanity checks in the form of finite state automata. The resulting invariants describe the behavior of sanity checks that can divert the control from reaching the region of interest.

Embodiments of the present invention may further use source code instrumentation to monitor the execution of the whole program. The instrumentation is designed to detect executions that reach the target region of interest and monitor the utilization of resources, such as CPU time, stack depth, and heap memory. The instrumentation computes a feedback score for each execution based on these factors. A higher feedback score is given to inputs that progress farther through the sanity checks and cause higher resource utilization, such as longer execution time, more memory usage, higher recursion depth and so on. Finally, evolutionary techniques, such as Covariance Matrix Adaptation (CMA), is used to search among the inputs that satisfy the invariants generated from the sanity checks for an input that maximizes the feedback value. In this manner, embodiments of the present invention automatically discover denial of service vulnerabilities and generate the inputs that can exploit those vulnerabilities. The amount of user input during the process is minimal. Furthermore, experiments have shown that embodiments of the present invention are capable of discovering vulnerabilities in code that were not previously known. Using this set of inputs as a guide, the code of the software program can then be edited to protect the system against resource exhaustion vulnerabilities.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

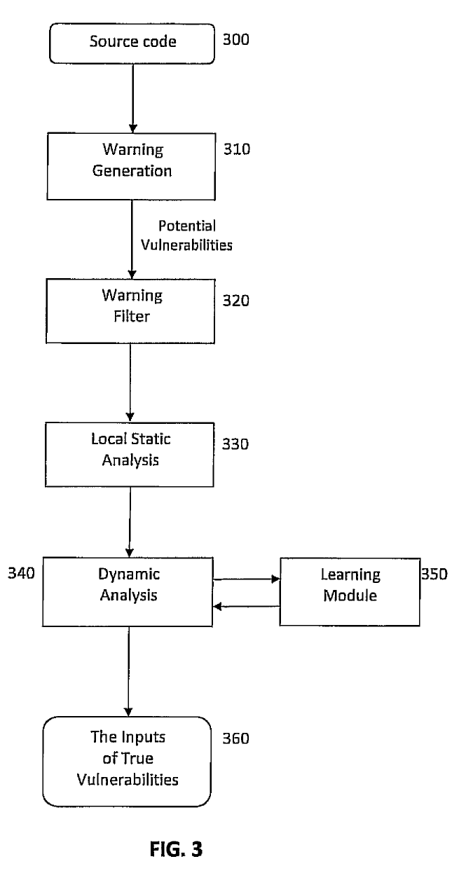

Reference will now made to the drawings in which like numerals represent the same or similar elements and initially to FIG. 3. FIG. 3 is a block/flow diagram representing an overview of one embodiment of the present invention. Block 300 represents the source code of the software program to be analyzed. The process begins in block 310 by generating vulnerability warnings. In this block, a set of potentially long running segments of source code are identified. Then, static analysis is applied to this set to flag segments whose running time is a function of user-supplied input. This set of potentially vulnerable code segments is further refined by a warning filter 320, which applies analyses (such as reachability analysis and range analysis) to remove warnings that are unlikely to be exploitable via a CPU exhaustion attack.

Then, in block 330 local static analysis is performed which profiles the control flow of the suspicious segments with automata and further maps the automata into regular string expressions. These regular expressions then undergo a dynamic analysis 340. The dynamic analysis works in conjunction with learning module 350 to generate the inputs that can exploit the identified vulnerabilities 360. These inputs can then be used to analyze the program code for security flaws and edit the program code to protect against these flaws. Thus, the present principles may be used to transform a system vulnerable to resource exhaustion attacks into a secure system not susceptible to such attacks.

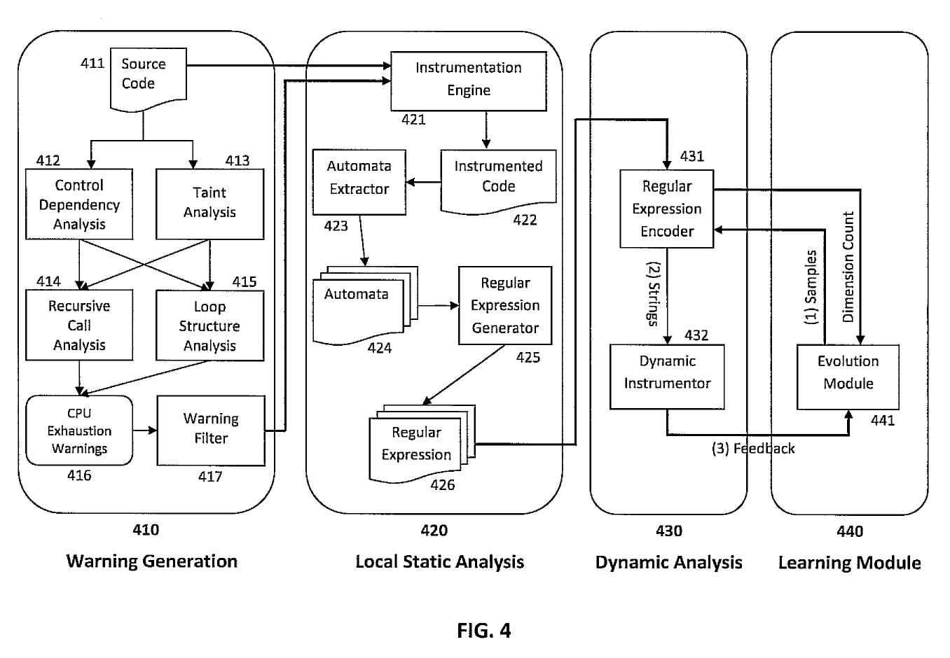

FIG. 4 depicts an illustrative embodiment of the present invention in greater detail. Block 410 represents the warning generation phase of the testing process. During this phase the program source code 411 undergoes a control dependency analysis 412 and a taint analysis 413. The control dependency analysis 412 utilizes a flow-insensitive, points-to analysis to construct a points-to graph that identifies the potential aliasing relationships between pointers, arrays and memory allocated at dynamic allocation sites.

Taint analysis has been well studied as a dynamic analysis. It has been used in both scripting languages, such as perl, to avoid user input flowing into sensitive functions such as “exec” and in tools such as DyTan. Static taint analysis identifies information flow patterns among variables in the program. The taint analysis 413 in accordance with the present principles performs a static flow and context sensitive taint analysis using function summaries. A variable x in the program is said to be tainted if its value is shown to be a direct function of the user input. To handle enterprise systems which communicate with clients through sockets, embodiments of the present invention may distinguish taints arising from local inputs, such as configuration files, and those arising from data read from a remote user.

The outputs of the control dependency analysis 412 and the taint analysis 413 then undergo recursive call analysis 414 and/or loop structure analysis 415. CPU and stack exhaustion attacks arise from long running loops in the code that can exhaust the CPU or deep recursive function calls that can potentially exhaust the stack. Thus, the key idea behind these analyses is to identify recursions and loops whose exits are controlled by a tainted condition. Such recursions and loops are potentially vulnerable. To identify such loops and recursions, the framework relies on the results of the taint analysis.

The loop and recursion analyses produce a set of all potential code segments that can possibly cause CPU exhaustion, 416. However, as discussed previously, this set may include many false positives. To limit the number of false positives, the CPU exhaustion warnings are passed through a warning filter 417. Among some of the analyses the warning filter 417 may employ are a reachability analysis and a range analysis. The reachability analysis structurally analyzes the identified loops and recursive calls by enumerating all the reaching contexts. The warning filter then refines the set of potential vulnerabilities based on these contexts. The range analysis refines warnings based on a loop nesting analysis that heuristically predicts the complexity of the given loop in terms of its nesting depth.

The program source code and the target vulnerabilities pointed out by the preceding warning generation 410, are sent to the local static analysis 420. The local static analysis 420 performs input processing and sanitization on the code paths leading up to the vulnerabilities to restrict the set of inputs that reach a specific program location. More specifically, the warnings from the warning filter 417 and the original source code 411 are sent to an instrumentation engine 421 which instruments the segments of the source code that are potentially vulnerable to denial of service attacks. Often, the input sanitization is performed in response to prevent inputs of coma for previously known vulnerabilities.

The instrumented code 422 produced by the instrumentation engine 421 is then processed by an automata extractor 423 which seeks to characterize the effect of the input sanitization code in terms of the inputs that may reach the warning. The automata extractor 423 seeks to identify the set of input strings that can clear the sanity checks placed on the inputs and reach the warnings. In general, this is a difficult problem and as such, beyond the reach of most automatic static analysis. Therefore, embodiments may be relaxed to allow for an approximation of the set of strings. Specifically, the automata extractor 423 seeks to overapproximate the set of strings as a regular language represented succinctly by a finite state automaton.

Static analyses of string expressions in programs have focused on computing invariants that characterize the contents of string variables in programs by means of finite state automata. One string expression analysis of the prior art provides a static analysis framework that can characterize the values of a string variable at a particular program point as a regular language in a sound fashion. This analysis is implemented in the Java String Analyzer (JSA) tool that automatically analyzes Java programs to characterize the contents of string variables at each program point. Given a Java program the tool can be used to output an automaton characterizing the possible values stored in each string at each program location. This has been adapted by many others to support various other operations over strings such as support for language-based replacement and so on. Other prior art has proposed an abstract interpretation approach based on automata to represent strings to analyze the behavior of sanitization loops in PHP code. Their approach supports a wide variety of string manipulations encountered in such systems including restrictions based on conditional branches.

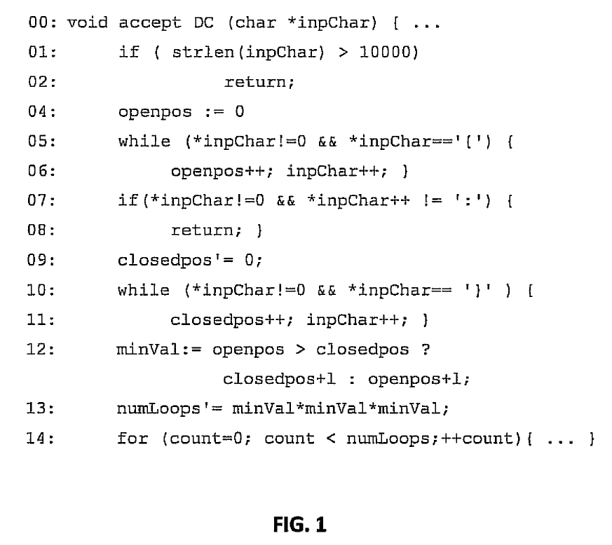

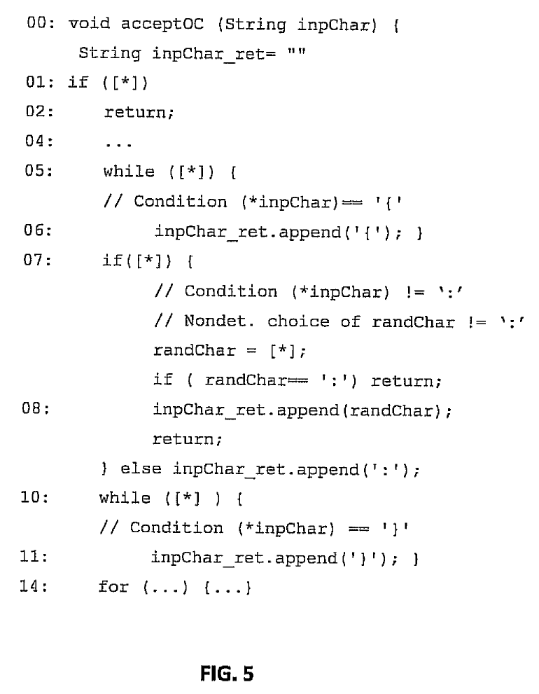

FIG. 5 shows the abstraction obtained for the example in FIG. 1. The effect of the conditional branches over the characters in ‘inpChar’ is captured by the string ‘inpChar_ret’. The JSA analyzer can analyze the function shown in FIG. 5 and infer the pattern ‘{‘* ‘+’ ‘}’* at line 14. To this output, the pattern Σ* is appended to account for the unprocessed suffix of the string. The output of the string analysis performed by the automata extractor 423 is a finite state automaton representation 424 for each segment of vulnerable code.

The automata 424 are then converted into regular expressions 426 by a regular expression generator 425. In one embodiment, the regular expression generator 425 uses a standard conversion technique based on transitive closure to generate the regular expressions 426. The regular expression generator 425 also simplifies the expressions to compact characters based on character classes, such as alphanumerics, numbers, symbols and so on, wherever possible. These classes are automatically suggested by the use of functions, such as isAlpha and isNum, that test the membership of characters in such classes. They are also obtained by compacting repeating patterns of the form (a₁|a₂| . . . |aₙ) that occur frequently in the regular expression.

In certain embodiments, the regular expression generator 425 may further derive a parameterized regular expression R′(i₁, . . . ,iₙ) by replacing each occurrence of the Kleene star * operator with a parameter iₖ. For instance, the parameterization of the expression ‘{‘* ‘:’ ‘}’*.* yields the parameterized expression ‘{‘i₁ ‘:’i₂ .i₃, with three parameters (i₁, i₂, i₃). Given some instantiation of the parameter, we obtain a star-free regular expression (formed by concatenation and disjunction). Such an expression represents a finite set of strings that can be enumerated by a traversal of the regular expression tree.

Parameterization is used in the framework of the present principles to restrict the search for inputs of coma among the strings satisfying a regular language into a search in the space of numerical values to the corresponding parameters. Any integer solution to the parameters immediately yields a string or a set of strings in the original language.

Unfortunately, the process of parameterizing a regular expression does not always preserve the original regular expression. This can be seen by considering the treatment of nested applications of the Kleene-star. A naive parameterization of the regular expression R:(a*b)* yields the parameterized expression R′(i,j):(aⁱb)^{j} with parameters (i, j). However, the parameterization implicitly restricts the language of the underlying expressions. For instance, no instantiation of i,j in the expression above can yield the string s₀:aabbaaabbb that clearly belongs to the regular language.

The drawbacks of parameterization can be alleviated in part by using a more fine-grained approach that expands nested Kleene star operators. For instance, we may unwind the expression R:(a*b)* into the expression R′(i₁,i₂,i₃,j₁,j₂,j₃):(aⁱ^{₁}b)^{j}^{₁}(aⁱ^{₂}b)^{j}^{₂}(aⁱ^{₃}b)^{j}^{₃}. The number of unwindings is an a priori fixed parameter. The empty string may still be derived in this parameterization by setting the values j₁=j₂=j₃=0. Such an unwinding can capture the string s₀ above. However, the unwinding cannot capture the string s₁:(aabaaab)²⁰ which is part of the original language. An alternative is to unroll the expression to obtain the parameterization R′(i₁,i₂,i₃,j₁,j₃):(a₁¹ba₂¹baⁱ^{₃}b)^{j}. This can capture the string s₁ described above but not the string s₀.

Embodiments of the present invention parameterize a Kleene-star R* using unwinding and unrollings of depth d systematically. If R does not include a Kleene-star operator, we simply parameterize it as R′:R^{j}. If R does include instances of the Kleene-star, R* is parameterized as Rⁱ^{₁}Rⁱ^{₂} . . . Rⁱ^{_{d}} (R^{j}^{₁} . . . R^{j}^{_{d}})^{k} using 2d+1 parameters. The overall parameterization starts by parameterizing the outermost instances of Kleene-star proceeding inwards.

At this point, there is a parameterized regular expression R(x₁, . . . ,xₙ) with dimensional variables x₁, . . . ,xₙ such that fixing nonnegative integer values to x₁, . . . ,xₙ, chooses a set of strings s₁, . . . ,sₘ each of which satisfies the regular expression R. Parameterizing the regular expression conveniently transforms a complex search in the space of satisfying solutions to a regular expression into a search among a set of integer points that are unconstrained. The size of the search space may be limited by limiting the strings to some fixed length. This is achieved by imposing the constraint x₁+ . . . +xₙ≦N for some N≦0.

The regular expressions of string sequences 426 generated by the local static analysis 420 are sent to the dynamic analysis tool 430. The dynamic analysis tool 430 works in conjunction with the learning module 440 to find inputs of coma by generating input samples based on the regular expressions 426 and running the segment of suspicious source code with the generated input samples while monitoring resource utilization.

A regular expression encoder 431 receives the regular expressions and sends the number of dimensions to the evolution module 441. The evolution module 441 generates an input that it believes will invoke the biggest number of loops or calls. This input is sent to the regular expression encoder 431 which maps the results from the evolution module 441 into the inputs of the program. A dynamic instrumentor 432 runs the segment of code with the inputs provided by the evolution module/regular expression encoder. While the code is being run, the dynamic instrumentor 432 monitors the resource usage as well as the behavior of the sanitization loop. Based on the amount of resource utilization, the dynamic instrumentor 432 calculates a feedback value for the given inputs. The feedback value will be higher for inputs that pass the program's sanity checks and cause larger resource utilization. The feedback value is sent to the learning module 441 which uses it to help determine inputs that will cause higher resource utilization. This process may be repeated for any set amount of time or set amount of iterations.

In one embodiment, the dynamic analysis is performed by searching for inputs as coma as a global optimization of a fitness function obtained through program instrumentation. In such an embodiment, the dynamic analysis comprises instrumenting the program to compute a fitness function that maps each run of the program to a numerical value based on the input reaching the target code along with the amount of resources consumed in terms of CPU time, recursion stack depth, memory allocated and so on.

The fitness function will now be discussed in further detail. Given a program P and an input s, let P(s) denote the trace obtained by running the program P on the input s. Dynamic observation is used on the trace to define a fitness function that is associated with the input s on the program P. The nature of the fitness function depends on the property of interest. Since the present application is interested in searching for inputs that lead to resource-heavy computation, the fitness function will produce higher values for inputs that cause higher amounts of resource utilization. Thus, embodiments of the present invention instrument the program to track resource usage in terms of time, memory and so on. Different resource usages may be combined simply by multiplying them.

Another important problem that is faced in practice is to formulate inputs that pass through the sanity checks placed on them. The local static analysis 420 described previously provides a regular approximation of the sanity checking code that partly alleviates the problem of producing an input. However, the static analysis assumed that the set of strings that pass the sanity check was a regular language. In reality, the set of strings may not be regular. The problem caused by the possibility of an irregular language set of strings is solved by augmenting the fitness function to provide lower weight to the fitness scores of inputs that do not pass the sanity checks.

The method behind the search for inputs of coma will now be described in more detail. The search itself assumes that the set of inputs for x₁, . . . ,xₙ are real numbers. Any real number valuation of the variables is converted to an integer valuation by rounding the fractional parts. Then, the fitness functions described above may be translated over parameter values by simply converting each parameter valuation to a set of strings and obtaining the maximum fitness function value amongst the strings so obtained.

The fitness function ƒ(x₁, . . . ,xₙ) is evaluated by running the program P over the input strings s₁, . . . ,sₘ corresponding to the instantiation of the regular expression by (┌x₁┐, . . . ,┌xₙ┐). The inputs of coma will maximize the fitness function for a given size limit N. Finding such inputs would normally employ a global search over the set of all values of the input parameters. This search is prohibitively expensive even for small examples.

The present principles, however, utilize heuristic and evolutionary techniques to significantly reduce the breadth of the search. The heuristic and evolutionary techniques draw on at least some of the following observations about the problem of searching for inputs of coma:
1. Frequently, inputs of coma depend on exact relationships between the parameters in the problem. There is generally a simple pattern amongst the inputs that maximize the fitness values for a given limit N. In many cases, this pattern can be expressed succinctly as a function of N. Many of the case studies considered show striking examples of relatively simple input patterns that cause inputs of coma. For example, consider the program shown in FIG. 1. The parameterized regular expression {ⁱ:}^{j} Σ^{k} yields the maximum resource utilization for a size limit N following the pattern {N/2:}^{N/2}.
2. Even in cases where the pattern is too complex to express succinctly, there are strong correlations and anti-correlations between certain dimensions. The inputs of coma are learned by making quantitative inferences about the pair-wise correlations between these dimensions.
3. A vast majority of the dimensions involved do not contribute to the fitness function and can be dropped. Identifying these dimensions and setting them to the lowest values possible is key to the search.
4. Finally, the nature of the fitness landscape is smooth, meaning that nearby inputs cause nearly as much resource utilization. Thus, inputs that are close by in the parameter space tend to have fitness functions that are close to each other.

Using the above facts, embodiments of the present invention provide a method to determine inputs of coma without the need to perform a global search.

Regarding the evolution module 441, in one embodiment the Covariance Matrix Adaptation Evolution Strategy (CMA-ES) is used. The CMA-ES is an evolutionary strategy that tries to learn the correlations amongst the different dimensions in the search iteratively and apply random sampling at each step by taking such correlations into account. At its core, the CMA-ES attempts to approximate the overall fitness function by means of a multivariate Gaussian distribution with mean μ and variance matrix C that captures the mutual pairwise covariances amongst the different dimensions and the variance inside the dimension.

The following instructions present a high-level overview of the strategy of the CMA evolution method:

```
Input: Number of dimensions
Initialize distribution parameter μ₀, C₀:
/ /For generations i = 0, 1, 2, 3, ...
    while not termination criteria met do
        Sample m points from distribution:
        Evaluate sample points based on an objective
    function j:
        Update the distribution parameter μ, C;
    End
```

The evolution method samples a few points in the search space and evaluates these sample points based on an objective function. The evolution method selects updated distribution parameters based on the samples and their fitness values. The new parameters guarantee higher densities where the fitness functions are the largest. Therefore, good samples in the current generation are used to sample new points in the next generation.

The CMA method will now be discussed in more detail. The method starts with an initial distribution C₀, μᵢ₊₁. At each evolution step i, the distribution Cᵢ₊₁, μᵢ₊₁ is updated as follows: First, sample m>0 points according to the Gaussian distribution C₁, μᵢ. Let \vec{x}₁, . . . ,\vec{x}ₘ be the sampled points ranked in the decreasing order of their fitness functions ƒ(\vec{x}₁), . . . , ƒ(\vec{x}ₘ). Then the mean and the covariance matrices are updated based on the sampled points \vec{x}₁, . . . ,\vec{x}ₘ. This update can be performed in many ways. However, as a general rule, the points are weighted in importance so that the resulting Gaussian distribution has its highest density around the points with the highest fitness and lowest densities corresponding to the lowest fitness function. In some embodiments, the points sampled from the previous iterations of the process may also be considered.

One embodiment computes a fixed number of evolutionary attempts at adapting the Gaussian distribution followed by sampling based on the distribution. At the conclusion of this process, the input with the highest value for the fitness function is chosen as a near optimal input.

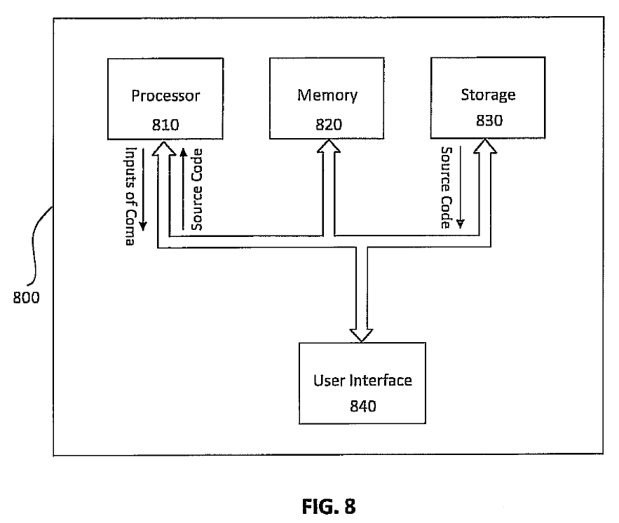

FIG. 8 is an exemplary embodiment of a denial of service detection system 800 into which embodiments the present invention is incorporated. The system 800 may be part of a debugging/program checking work station or may be a stand-alone system. The system includes a processor 810 which receives the program source code to be analyzed. The processor 810 performs the necessary warning generation, local static analysis and dynamic analysis described herein and outputs the inputs of coma for the given source code. The inputs of coma may be sent to the user interface 840 for review by a user or may be stored in memory 820 or storage 830, for example in a file or database. During the analysis process, the processor may employ system memory 820, for example, to store the automata and regular expressions created. The memory 820 may be any type of memory storage including, for example, one or more of random access memory (RAM), flash memory, hard drives and solid state drives.

The system 800 also includes a storage device 830 on which, at least, the program source code to be analyzed is stored. The storage device 830 may be a physical storage device, for example one or more hard drives, flash drives and solid state drives. The storage device 830 may also be a media reading device into which media storing the source code may be inserted, for example a CD/DVD reading drive into which a CD or DVD which stores the source code may be inserted. The system further includes a user interface 840 for interaction between a user and the system.

In one illustrative embodiment, the present principles are embodied in a tool used by manufacturers of electronics or computer equipment during the development of their products. Examples of equipment on which such a tool would be particularly useful include servers, laptop computers, desktop computers, cell phones, smart phones, PDAs, networking hubs and routers, and other electronic equipment (this list is included for illustrative purposes only and should not be construed to suggest any limitation on the scope of present invention). The tool implementing the present principles may be used by manufacturers to test the resiliency of their products against resource exhaustion attacks which may cause the device to crash. The manufacturers may then use the inputs of coma discovered by the tool to analyze the software code being run on the device (for example the operating system or an application) for loopholes in the security measures of the system. These security flaws can then be patched by editing the program code to guard against the resource exhaustion caused by the inputs detected. In this manner, manufacturers may advantageously use the present principles to provide an electronic or computer product which is less vulnerable to system crashes.

In another illustrative embodiment, the tool embodying the present principles is incorporated into electronic or computer device itself. In this embodiment, the present principles may further be used to aid in the servicing and repairing of the device after a system failure. After receiving the device from the user, the service technician may then use the tool embodying the present principles to try to reenact the circumstances under which the system failed and discover the cause of the system crash. Once the cause of the crash is discovered, the system or application software can then be patched, as described above, to eliminate this vulnerability in the system and prevent such a system crash from occurring in the future.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method of determining resource exhaustion denial of service vulnerabilities in a computer device, comprising the steps of:
generating vulnerability warnings by scanning the program source code and locating potential vulnerabilities;
applying a warning filter to remove from the set of potential vulnerabilities warnings that are unlikely to be exploitable by a resource exhaustion attack, wherein the warning filter uses at least one of a reachability analysis and a range analysis; and
generating one or more user inputs that will cause resource exhaustion by:
performing local static analysis on the set of potential vulnerabilities to profile the control flow graph of potentially vulnerable code segments, and
performing a dynamic analysis which employs a learning module to generate the inputs that can exploit the vulnerability of each code segment; and
modifying the program code, thereby producing new program code which protects the computer device from resource exhaustion vulnerabilities.

2. The method of claim 1 wherein the warning generation step comprises the steps of:
performing a control dependency analysis to identify the potential aliasing relationships between pointers, arrays and memory allocated at dynamic allocation sites;
performing a taint analysis to flag segments of the source code that are direct functions of user input;
performing a recursive call analysis which takes the outputs of the control dependency and taint analyses and identifies recursions whose exit conditions are controlled by user input; and
performing a loop structure analysis which takes the outputs of the control dependency and taint analyses and identifies loops whose exit conditions are controlled by user input.

3. The method of claim 1 wherein the reachability analysis structurally analyzes the identified loops and recursive calls by enumerating all the reaching contexts and filters the warnings based on these contexts.

4. The method of claim 1 wherein the range analysis refines the warnings based on a loop nesting analysis which heuristically predicts the complexity of a given loop or recursive call in terms of its nesting depth.

5. The method of claim 1 wherein the step of performing local static analysis comprises the steps of:
instrumenting the vulnerable code segments by performing string analysis;
extracting automata from the instrumented code to profile the control flow of the code segments and identify the set of input strings that can reach the vulnerable code segment; and
generating regular expressions from the extracted automata.

6. The method of claim 5 wherein the step of generating regular expressions includes parameterizing the expressions by replacing each occurrence of a Kleene star with a parameter.

7. The method of claim 6 wherein the step of parameterizing the regular expressions further includes performing a sensitivity analysis to reduce the number of dimensions present in the regular expression.

8. The method of claim 1 wherein the step of performing dynamic analysis which employs a learning module comprises the steps of:
receiving a regular expression;
sending the number of dimensions in the regular expression to an evolution module;
and iterating through the steps of:
generating inputs at the evolution module;
sending the generated inputs to a regular expression encoder which maps the inputs into the code segment;
running the code segment with the mapped inputs at a dynamic instrumentor which monitors resource utilization and calculates a feedback score based on the amount of resource utilization; and
sending the feedback score to the evolution module which uses the score to generate inputs that will cause the highest amount of resource of utilization.

9. The method of claim 8 wherein the iteration is limited by a set number of iterations or a set time period.

10. The method of claim 8 wherein the feedback score is calculated using a fitness function.

11. The method of claim 8 wherein the evolution module is the Covariance Matrix Adaptation evolution strategy.

12. A computer program product, comprising a computer usable medium having a computer readable program embodied thereon, wherein the computer readable program when executed on a computer causes the computer to perform method steps for determining portions a software program that are vulnerable to resource exhaustion denial of service attacks caused by user input and generating the user input(s) that will cause resource exhaustion, as recited in claim 1.

13. The computer program product as recited in claim 12 wherein the computer readable program further causes the computer to perform the method steps recited in claim 2.

14. The computer program product as recited in claim 12 wherein the computer readable program further causes the computer to perform method steps recited in claim 5.

15. The computer program product as recited in claim 12 wherein the computer readable program further causes the computer to perform method steps recited in claim 8.

16. A system for detecting denial of service vulnerabilities in a software program, comprising:
a processor for performing warning generation, local static analysis and dynamic analysis,
wherein the warning generation comprises generating vulnerability warnings by scanning the program source code and locating potential vulnerabilities and applying a warning filter which uses at least one of a reachability analysis and a range analysis to remove from the set of potential vulnerabilities warnings that are unlikely to be exploitable by a resource exhaustion attack,
wherein the local static analysis is performed on the set of potential vulnerabilities to profile the control flow graph of potentially vulnerable code segments, and
wherein the dynamic analysis employs a learning module to generate the inputs that can exploit the vulnerability of each code segment;
memory storage for storing the automata and regular expressions created;
a storage device on which the program(s) to analyzed are stored; and
a user interface to allow a user to interact with the denial of service detection system.

17. The system recited in claim 16 wherein the user interface further allows a user to modify the program code to protect the system from the resource exhaustion vulnerability.

18. A system for detecting denial of service vulnerabilities in a software program, comprising:
a processor for performing warning generation, local static analysis and dynamic analysis,
wherein the warning generation comprises generating vulnerability warnings by scanning the program source code and locating potential vulnerabilities and applying a warning filter which uses at least one of a reachability analysis and a range analysis to remove from the set of potential vulnerabilities warnings that are unlikely to be exploitable by a resource exhaustion attack,
wherein the local static analysis is performed on the set of potential vulnerabilities to profile the control flow graph of potentially vulnerable code segments, and
wherein the dynamic analysis employs a learning module to generate the inputs that can exploit the vulnerability of each code segment;
memory storage for storing the automata and regular expressions created;
a media reading device for reading removable media on which the program(s) to analyzed are stored; and
a user interface to allow a user to interact with the denial of service detection system.

19. The system recited in claim 18 wherein the user interface further allows a user to modify the program code to protect the system from the resource exhaustion vulnerability.
